(19) United States
(12) Patent Application Publication
(10) Pub. No.: US 2021/0247882 A1
(43) Pub. Date: Aug. 12, 2021

(54) COMPUTER-BASED METHOD AND SYSTEM FOR MULTIDIMENSIONAL MEDIA CONTENT ORGANISATION AND PRESENTATION

(71) Applicant: Norman & Globus, Inc., Richmond, CA (US)

(72) Inventors: Penelope A. Norman, Richmond, CA (US); William S. Moulton, Richmond, CA (US); Damir Pecnik, Richmond, CA (US)

(21) Appl. No.: 16/787,347

(22) Filed: Feb. 11, 2020

(51) Int. Cl. G06F 3/0484; G06F 3/0481; G06F 40/134

(52) U.S. Cl. CPC G06F 3/0484; G09B 7/08; G06F 40/134; G06F 3/0481

(57) ABSTRACT

Computer based method for multidimensional media content organization and presentation are described herein. The method and system facilitate non-programmer configuration and construction of adaptive education and learning user interfaces, using multiple adjacent display of interactive knowledge media as content frames, and manual and automated adaptive configuration construction, selection, sequencing, and conditional switching between content frames within a given named frame collection, and the sequencing and switching between named collections or groups of content frames.

### FIELD OF THE INVENTION

Embodiments described herein in general, concern adaptive interactive multi-window, multi-screen, multi-frame, multimedia software construction system for deployment in education, learning and training applications.

### BACKGROUND OF THE INVENTION

This described subject matter relates generally to use of computer interactive multimedia internet technology to support learning in the field of education. In many cases teachers working without computer aided learning tools seek to provide interactive student learning environments. Teachers lead and guide students using narrative about specific curricula content to be taught. They will introduce ideas, concepts and knowledge content in several dimensions, including verbal, static visualization, animated visualization, interactive question and answer, and problem and solution exercises, in order to convey curriculum content scope and better effect student comprehension of content concepts and principles being taught, and seek to assess the measure of student comprehension and learning.

Computer aided learning tools, are called in the prior art: Learning Management Systems (LMS). LMS are presently used today to present educational content in textual, visual, and interactive media formats, including audio, video and interactive simulations, to provide comprehensible exposition of knowledge, and then subsequently are used to assess student comprehension through the use of testing, quizzes, grading, exercises and reports. Student learning is attested through performance, testing and assessment. As students fail in performance, testing, and assessment, teachers will often adapt the teaching method to further assist the learning process for the student. Most LMS methods support both timed and self-paced learning, and depending on testing assessment results will move forward when learning is successful or modify the approach to teaching when learning is not successful.

In practice, certain LMS approaches to teaching and learning tend to be more successful than others. Much can be taught through textual reading, exposition, story narrative and mathematical language. Student capacity to learn and comprehend can be enhanced by increasing how much participation is engaged on the part of the student asking questions, actively working through steps of problem analysis, working with application examples of concepts, self-pacing, and interactively exploring or manipulating models to illustrate the embodiment of concepts being taught. It is established in the existing prior art pedagogy that learning and retention of different subjects can be accelerated and enhanced through the use of teaching aids such interactive physical models, laboratory activity, visual illustration, gaming, and multimedia exposition.

### SUMMARY OF THE INVENTION

Computers are increasingly being utilized to support online learning. The present subject matter deploys an electronic interactive multimedia graphical user interface (GUI) for learning comprised of a plurality of frames visible simultaneously on the computer monitor screen, which frames each contain different types of content and media which can be arrayed in a horizontal or matrix or other geometric layout and arrangement.

According to an embodiment, the present subject matter provides a method for multidimensional media content organization and presentation. The method comprises receiving one or more inputs from a user, defining at least a sequence for a plurality of content frames comprising portions of the multidimensional media content. The method further comprises organizing the plurality of content frames into a frame collection, depicting the organized multidimensional media content, based on the one or more inputs, storing the frame collection, and displaying the frame collection within a browser window of a display device.

In an embodiment, the one or more inputs include functional association of at least one of the plurality of content frames with at least another of the plurality of content frames.

In an embodiment, the one or more inputs include a number of content frames to be displayed simultaneously within the browser window; and a respective display position for each of the plurality of content frames with respect to other content frames within the browser window.

In an embodiment, the one or more inputs include a respective media content URL for each of the plurality of content frames, the media content URLs being associated with resources of the corresponding portions of the multidimensional media content.

In an embodiment, the one or more inputs include one or more action types to be associated with at least one of the plurality of content frames, wherein the one or more action types include a multiple action function, a single action function, a screen action function, and an external action function. The one or more inputs include action functions corresponding to the one or more action types.

The action functions define at least one of: at least one next content frame in the sequence for the plurality of content frames, a next portion of the multidimensional media content in the corresponding content frame, position of at least one next content frame within the browser window, triggering a chat box, prompting a user interaction, sending text and/or voice messages, triggering an external web page resource, monitoring user interaction with the plurality of content frames, and triggering a related content based on the monitoring, and triggering another frame collection.

In an embodiment, the method further comprises, after storing the frame collection, receiving one or more additional inputs for at least one of editing, viewing, cloning, and exporting the saved frame collection.

In an embodiment, displaying the frame collection comprises displaying at least two of the plurality of content frames and corresponding portions of the multidimensional media content.

In an embodiment, the one or more inputs include: a number of content frames to be displayed simultaneously within the browser window, the number of content frames to be displayed simultaneously within the browser window being at least two, a respective display position for each of the at least two content frames with respect to other content frames within the browser window, and functional association of at least one of the at least two content frames with at least another of the at least two content frame; and displaying the frame collection comprises displaying the at least two content frames adjacent to each other within the browser window, thereby providing graphically separated and functionally associated content engagement.

In an embodiment, displaying the frame collection further comprises: detecting a stimulus event associated with at least one of the plurality of content frames, triggering at least one action function associated with the at least one content frame, and changing the display in response to the triggering. Further, the stimulus event comprises a user interaction associated with the at least one of the plurality of content frames. Furthermore, triggering at least one action function may comprise prompting a further user interaction, and displaying the frame collection may further comprise: receiving the further user interaction, generating an interaction log based on the user interaction and the further user interaction, and storing the interaction log in association with the frame collection.

The further user interaction may comprise at least one of addition of notes, annotations, chat, discussion forum inputs, feedback messaging, and request to view stereoscopic 3D content, speech inputs. The interaction log may comprise time stamps associated with the user interaction and the further user interaction.

In another embodiment, the present subject matter provides a system for multidimensional media content organization and presentation. The system includes at least one processor and a memory that is coupled to the at least one processor and that includes computer-executable instructions. The at least one processor, based on execution of the computer-executable instructions, is configured to receive one or more inputs from a user, defining at least a sequence for a plurality of content frames comprising portions of the multidimensional media content. The at least one processor is further configured to organize the plurality of content frames into a frame collection, depict the organized multidimensional media content, based on the one or more inputs, store the frame collection, and display the frame collection within a browser window of a display device.

In another embodiment, the present subject matter provides a computer-readable medium that comprises computer-executable instructions for multidimensional media content organization and presentation. The computer-executable instructions, based on execution by at least one processor of a computing device that includes memory, cause the computing device to receive one or more inputs from a user, defining at least a sequence for a plurality of content frames comprising portions of the multidimensional media content, organize the plurality of content frames into a frame collection, depict the organized multidimensional media content, based on the one or more inputs, store the frame collection, and display the frame collection within a browser window of a display device.

In an embodiment of the present subject matter for online learning use on the internet there are a minimum of two framed media content areas within a larger single browser window on the left and right side of the device display screen where said dual frames within a singular window, are displayed. If two frames are deployed then the user views what may be called a “split screen” of media content that are both displayed and contained within a larger internet browser display window or application software display window that may or may not be connected to the internet at the time of display. There is a minimum plurality of at least a dual screen or split screen, or two frames of content, displayed side-by-side. This multi-frame content display permits the accomplishment of a wide variety of pedagogical style teaching and exposition methods to be deployed, whereby at least two aspects or two perspectives or two dimensions or any dualistic exposition of content and alternate mapping of knowledge can occur in concert for the student, thus enhancing by means of the use of multiple mediums of exposition, the learning process.

An object of the present subject matter is enabling the deployment of a plurality of frame-to-frame relationships that are dependent on the human-machine interaction, deploying of a set of specific methods and algorithms utilized to selectively change and sequence media and knowledge content contained within one or more visible frame content areas within the larger window, in order to further both the efficacy and personalization of the interactive educational learning experience.

In modern pedagogical methodology, there is often a beneficial minimum of two sides to a story or argument, two stages of engagement, or two contrasting modes of expression of the same knowledge, which can be well suited to exploiting natural human bicameral modes of comprehension and perception. Examples application knowledge exposition dualisms include: theory and practice; thinking and doing; point and counterpoint, argument and counter-argument, pro and con, question and answer; problem and solution; if/then propositional syllogisms; input and output processing blocks; class and member logical typing distinctions, stimulus and response; analysis and synthesis; inductive reasoning and deductive reasoning; diagnosis and prescription, system states and transitions; singular statement and plural statement; initial condition and subsequent condition. There are numerous left and right brain learning and comprehension styles such as verbal and visual modes of expression and exposition such as a teacher speaking and also writing or drawing on a blackboard; narrative speech and visual illustration; hypothesis and experimental testing; proposition and examination; outline and in-depth information; general and specific information; structure and related process; foreground information and background information; information body and information references; legend and map; visible content and linked content; teacher and student activity; and any two party communication.

All of these identified dual divisions of knowledge and learning representation, processing, expression and demonstration can be accommodated in an embodiment of the present subject matter using a minimum of a dual frame or split screen or two side-by-side windowed information system, where the dual display are associated linked and can trigger changes in each other depending on the interactions that occur with a student, i.e., a user using the system. The object is to provide an online learning environment to better organize and exposit implicit or explicit divisions within the scope of the teaching curricula knowledge content itself, as associated with the domain and subject matter being studied, and to also naturalize the learning process to attend to the multidimensional means by which learning and comprehension can most effectively occur.

Further, user interactions within either contents of two or more frames, is supplemented with interactive controls external but associated to each frame, as action buttons, supplied to the student to be able to advance or change one or both of the windowed contents to other windowed content. These button features are independent and external to the framed media content itself, which content may be comprised of any type of embedded complexity and interactive component features and functionality. Within the present subject matter, a general set of frame-to-frame interactive functions are enabled which may be triggered to occur by the student interacting within the frame content media or external to the frames themselves by means to use of buttons or other external means.

### BRIEF DESCRIPTION OF THE DRAWINGS

FIG. 1 illustrates the Multi-Frame data processing stack.

FIG. 2 illustrates typical-front end GUI deployment of a dual screen display in a web browser to be used by a student.

FIG. 3 illustrates a sequenced display of front end GUI deployment of a dual screen display in a web browser to be used by a student.

FIG. 4 illustrates a dual multi-frame with interactive expert system chat frame with talking avatar and companion media frame.

FIG. 5 illustrates the Multi-Frame State Machine Operations.

FIG. 6 illustrates Frame and Multi-frame Content Retrieval Processing.

FIG. 7 illustrates a block diagram of the general algorithm of the back-end construction capabilities of the multi-frame display.

FIG. 8 illustrates a typical back-end GUI interface for configuring dual screen or split screen content and actions.

FIG. 9 illustrates the back-end selector function and configuration process of different types of button actions.

FIG. 10 illustrates the back-end configuration fields and editor layout for the Single Action type of button action.

FIG. 11 illustrates the back-end configuration fields and editor layout for the Multi-Action type of button action.

FIG. 12 illustrates the back-end configuration fields and editor layout for the External Action type of button action.

FIG. 13 illustrates the back-end configuration fields and editor layout for the Screen Action type of button action.

FIGS. 14A-14D illustrate the back-end process configuration set up process for each type of Button Action.

FIG. 15 illustrates an example multi-frame sequence control stack configuration.

FIG. 16 illustrates the interconnected interconnection flow between a named frame, frame related buttons, as collections into other named collections of frames in a sequence hierarchy.

FIG. 17 illustrates Frame content detection for multi-frame content triggering.

FIG. 18 illustrates the training of a deep learning neural net in order to predict most optimal presentation choices for the student based on both history of recorded cohort student interaction logs.

FIG. 19 illustrates the Student UI Configuration Stack.

FIG. 20 illustrates the Producer UI Configuration Stack.

FIG. 21 illustrates the embodiment of the multi-frame system as an installable plugin component within a CMS such as Wordpress.

FIG. 22 illustrates the embodiment of the multi-frame system as in master list of multi-frame collections called “Screens” each with unique names.

### DETAILED DESCRIPTION OF THE INVENTION

The described subject matter is designed to improve, systematize, and make more accessible the non-programmer assembly and construction of rich multi-window multimedia content for teaching, training, and education purposes, and to provide deployed capability to improve the rate and depth of target knowledge subject content comprehension, content assimilation, learning and retention, and deliver more educationally effective student study and worker skill training capability.

The described subject matter embodies a multidimensional media content organization and presentation system whereby learning and knowledge content is contained in two or more window frames residing in a larger container window frame such as a browser window or a Learning Management System application software window which have access to networked content resources. The primary object of the described subject matter is twofold: to (1) enable a method whereby course instructors or teachers or trainers can, without any computer software programming experience, organize and orchestrate the interactive assembly and presentation of educational or training content, and (2) enable an interactive student or trainee learning environment that provides two or more visual regions or frames of content that can support intra-frame interaction and engagement, and inter-frame interaction and adaptive sequencing or switching.

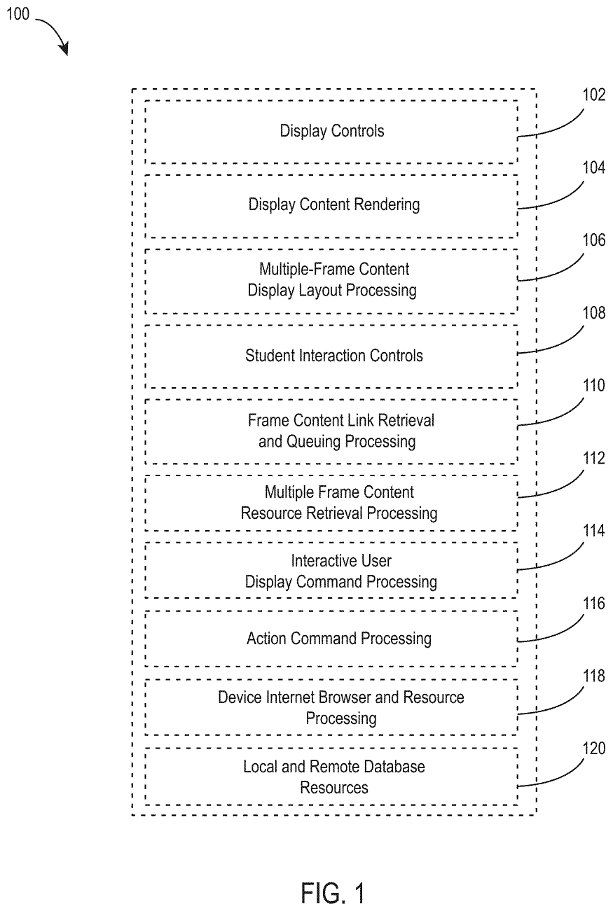

FIG. 1 illustrates a Multi-Frame data processing stack 100. The Multi-Frame data processing stack can include display controls 102, display content rendering 104, multiple frame content display layout processing 106, student interaction controls 108, frame content link retrieval and queuing processing 110, multiple frame content resource processing 112, interactive user display command processing 114, action command processing 116, device internet browser and resource processing 118, and local and remote database resources 120.

In an embodiment of the described subject matter a display with at least two separate educational content frames are shown side-by-side to a student or trainee, with each frame optionally captioned with a title, and with action buttons associated to each content frame adjacent to the frames offering various possible student interaction selections relevant to conduct within the frame, or sequencing to successive frames, or trigger changes in other frames, or to product external actions outside of the multi-frame system.

In one example simple embodiment, a content frame may display a quiz question within the frame to the student with answer options below the question provided as student selectable buttons. When the student makes a selection the frame content may change and advance to another frame to pose another quiz question, or alternatively provide feedback to the student based on their answer, or provide a different follow up quiz question based on the student answer. However, the present subject matter is not intended to replace other methods for performance assessment such as quizzes, although it may be deployed as a quiz system within the system. Instead, in practice, an entire quiz may be encompassed as an interactive activity contained within a single frame and only advance to the next frame of content when the first frame content quiz activity has been completed and the Action button adjacently displayed to the frame associated to the frame is selected by the student. Further, in practice, the appearance and display of certain buttons adjacent to the framed content activity may dynamically change depending on the activity of the student within the media of the singe frame.

A primary object of the described subject matter for teachers is to provide a general purpose flexible editing environment to configure and deploy rich multimedia content exposition within more than one area of the larger container screen, to thereby provide students with an interactive learning experience that is comprised of at least two graphically separated areas but functionally associated educational content engagement. The described subject matter provides students with a multi-windowed frame content display capable of supporting intra-frame interactions with the student and capable of providing the student with frame associated external action buttons whose selection can sequence or switch the display to show different content within existing displayed frames or add additional frames to view with their own interactive features and content focuses.

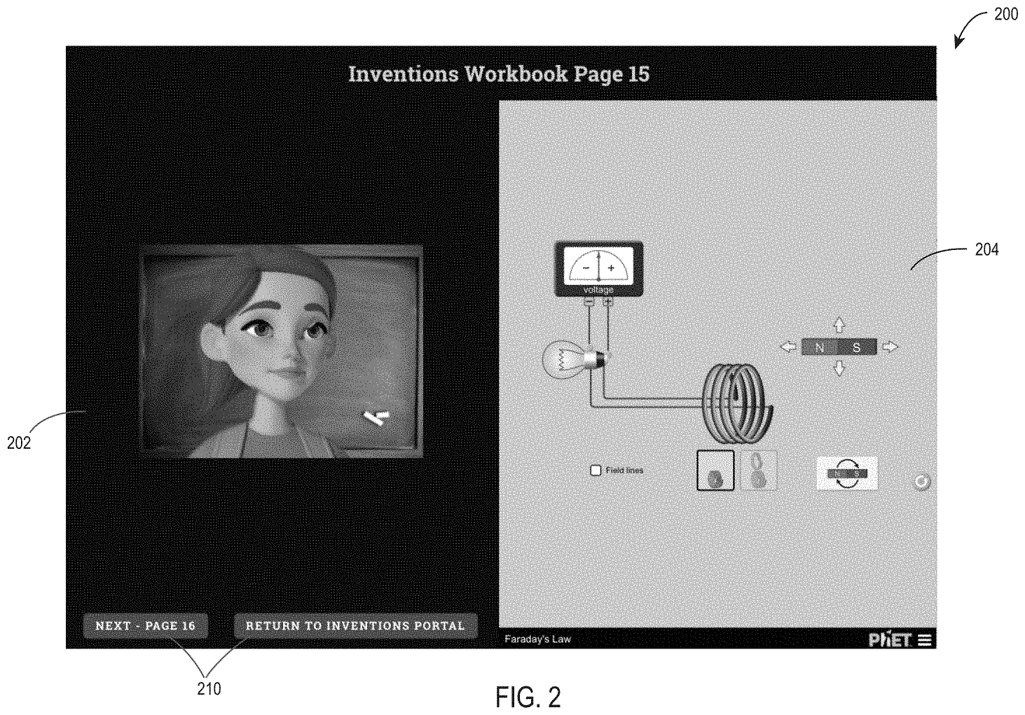

For example, in a present application of an embodiment illustrated in FIG. 2, showing a dual frame display layout in a web browser window, the student sees two separate frame areas having a left side frame 202, and a right side frame 204 on the screen, situated side-by-side within a larger single internet browser window 200, and also sees button actions 210 within the window that they can select below the media content frame areas, where the specific framed content consists of information that is “i-framed” from different URL(s) (Uniform Resource Locator) than the present browser window URL. In the practical application illustrated in FIG. 2, the student sees a speaking animated avatar on the left side frame 202, which is instructing the student about what they are viewing on the right side frame 204, which right side frame 204 is displaying an interactive graphical simulation of a particular knowledge topic, such as the nature of the relationship between magnetism and electricity for example.

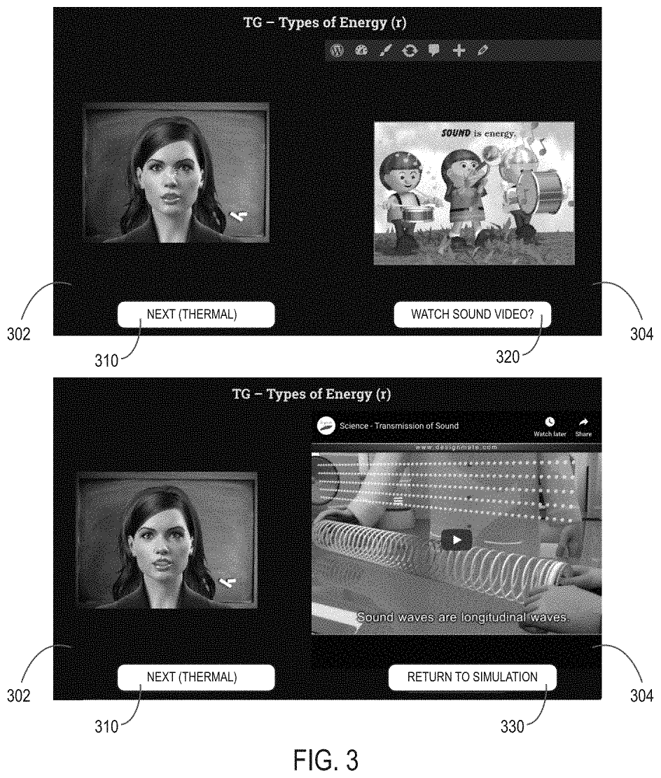

Further, in another practiced application of the capability, FIG. 3 illustrates a frame button action sequence of a dual frame display. The student first sees a speaking animated avatar on the left side frame 302, which is instructing the student about what they are viewing on the right side frame 304. In the left side frame 302, the talking avatar asks the student to familiarize themselves with certain features of the interactive simulation that exists in the right side frame 304, and asks them to try different interactions with the graphical simulation to see what happens. When the student is done with the suggested familiarizing or interaction with some aspect of the simulation the avatar may have asked or may subsequently ask the student to select the ‘Next’ button 310 immediately below the avatar frame (i.e., left side frame 302), or alternatively tells the student if they want to know more about the principles and concepts being shown, they can select button 320 below the simulation frame (i.e., right side frame 304) to switch it to showing a related or relevant Youtube video. Below the embedded Youtube video which is shown in the same frame as was the simulation (i.e., the right side frame 304), there appears a button with the text label ‘Return to Simulation?’ 330. If the student selects this button the frame reloads the simulation and returns to the earlier shown frame content of the interactive graphical simulation along with the frame associated buttons external to the frame.

Alternatively the student can select the ‘Next’ button 310 under the animated avatar in the left side frame 302, which loads a new animated avatar (not shown) and spoken script content frame, along with the same simulation as before if it was not previously visible because the Youtube video was still present in the frame, and then the speaking avatar proceeds to speak to and instruct the student to try other things with the graphical simulation on the right side frame 304.

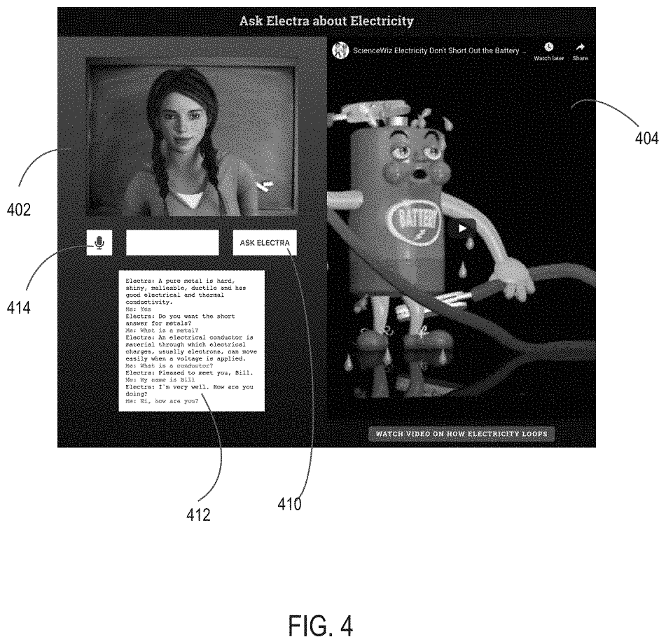

In another practical application regarding dual frame interactive frames with expert system chat frame with companion media frame illustrated in FIG. 4, the student sees a speaking animated avatar on the left side frame 402. The avatar speaks to ask the student if they understand the subject material, of the interactive simulation that exists in the right side frame 404, enough to try to take a quiz, or if they want to ask some questions. If the student wants to ask some questions they are asked by the speaking avatar to select the ‘Avatar Chat’ button (410) which loads in the left side frame 402 having the avatar along with a text chat window (412) inside the frame. The system supports speech-to-text conversion so the student simply clicks on the microphone icon (414) next to the chat box and verbally asks their question, which in response the Avatar, if the question and answer is in its AI database, then speaks the answer to the question.

Alternatively if the student is ready to take the quiz, the student can select the ‘Quiz’ button (not shown) below the avatar and a quiz program will be loaded into the same frame position where the speaking avatar was previously positioned and present. In an example, a quiz on the subject matter appears in the left side frame 402 of the large screen, and the quiz when completed, depending on the student performance with the quiz, if for example they get a perfect score, will provide the student with a reward, such as fireworks and sound effects, in a newly loaded frame (not shown). Below the reward frame there appears a button that is labeled ‘Return to Portal?’, which if selected will exit the current browser window URL and navigate to a different URL.

In an embodiment of the described subject matter, windowed or content media is populated by content from some related web resource and in the back-end editor designated by providing a URL address. Windowed content in the described subject matter includes but is not necessarily limited to text, animation, audio, video, screencasts, graphical imagery, diagrams and illustrations, slide shows, galleries, light box imagery, interactive graphical simulations, interactive AI expert system chat interfaces, animated speaking and listening instructional avatars, word play, crossword puzzles, quizzes and tests, forms to fill out, information tables, and active embedded URL links, that when selected remains within the confines of the frame. Such links may load into the frame PDF content, blog posts, any type of learning content exposition or learning media content.

Further, this content can include windowed display of any third party website, including any social interaction website, search bars, discussion forums, scrolling news, and any LMS related content. However, in the embodiment of the described subject matter certain standard option companion features and interactive facilities are always present in a third area such as a sidebar. An embodiment permits a plurality of any type or kind of windowed content to be displayed within each of the dual side by side windows showing within a single browser window or other application software display container that may be implemented in an LMS.

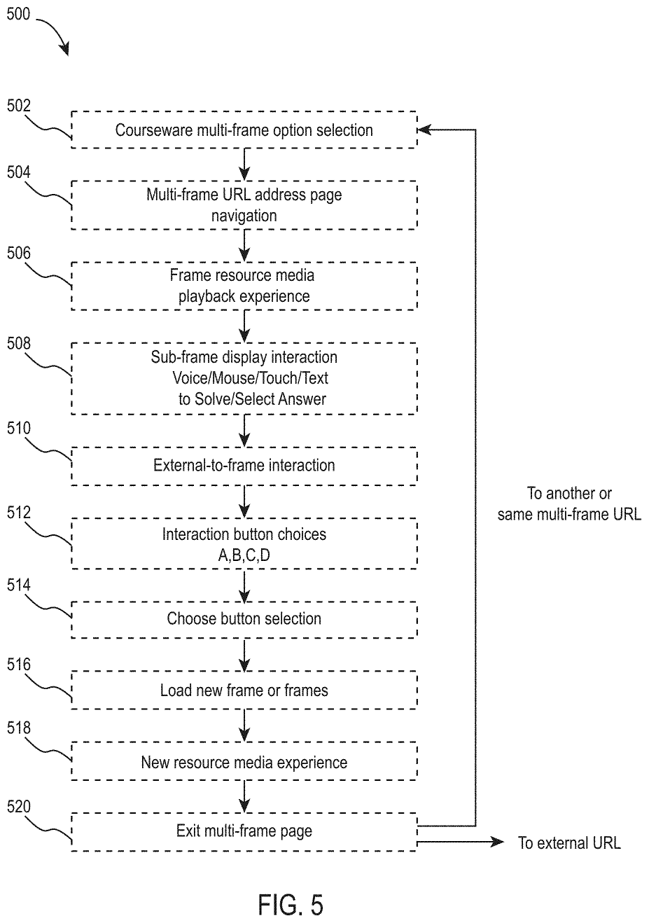

FIG. 5 illustrates a multi-frame state-machine operations 500 according to an embodiment of the described subject matter where a student interacts with content (such as a quiz question) displayed in the frame within a browser window. An initial frame of the multi-frame assembly (i.e., collection of frames for a topic or course) is selected in step 502. Selection of the initial frame triggers the associated URL in step 504, whereby content from the URL address page is retrieved. In step 506, the media content is displayed in the frame within a browser window, which may be, for example, a quiz question. Further, in step 508, interaction between the content in the frame and a user is enabled. The user interacts with the content via voice, mouse, text and/or touch. The interaction may be, for example, to solve the quiz question. In step 510, an external to frame interaction may be enabled. In step 512, action buttons may be provided external to the frame. The action buttons may represent, for instance, various answering options (such as, choices A, B, C, D) for the quiz question. In step 514, the user may select one of the action buttons. The selected action button may represent, for instance, the user's answer to the quiz question. In step 516, new frame(s) may be loaded within the browser window. In step 518, new content may be retrieved and displayed in the new frame(s). In step 520, the multi-frame assembly is exited. Further, the user may choose to navigate to an external URL or to another multi-frame assembly. In case the user decides to navigate to another multi-frame assembly, the steps of 502 to 520 may be followed for the new multi-frame assembly.

The generalized capability of the described subject matter may be described as comprising two or more independently addressable and external content provisioned media content frames populated by use of embedded content i-frames which are situated and arrayed within one or more browser windows, with additional frame related button controls situated outside the framed media content. A system controller effects frame-to-frame and multi-frame content transitions based on prior fixed or emergent conditions of student interaction within the frames or external to said frames containing i-frame content. The generalized algorithm for this follows a process whereby a designated change of state detected within or external to any frame can be prior or emergently assigned to effect a change of state to the same frame or other frame or multiple frames of media content by loading new content into one or more frames using i-frame methods.

The system operates to assemble, associate, and execute multi-frame display “action syllogisms” that follow a pre-designated stimulus-response pattern, which can include dynamically conditioned or static event stimulus to response action. Stimulus events pre-designated or trained to be detected within or in association to one frame can effect response events in the same frame and or other frames of information content display. Emergence of a set of detected stimulus conditions in more than one frame can also be required to effect a response action that changes the state of one or more frames. The system can effect a self-referential frame state change, such as loading new media content into the same frame, or effect a one frame stimulus to other frame change triggering, or multi-frame condition detection to effect a single or multiple frame state change of content. In an embodiment the system populates each frame by means of using URL links to media content that are displayed in a standard i-frame format.

Frame Stimulus Events. Varieties of frame state change trigger or “stimulus” events that are encompassed within the scope of the described subject matter include:
Passage of time, as an interval that is fixed or activity production dependent:
e.g. Timed interval;
e.g. Timed interval after another detected event;
e.g. Instantiated time interval in association to a particular task type;
   Degree of interactive engagement:
e.g. Opportunistic engagement level, or relative degree of active engagement
   User Interaction pattern, correct or incorrect user responses, ineffective or effective user engagements:
e.g. Compliant or non-compliant
   User text entry event: keyword or key phrase detection;
   User text entry event: semantic meaning detection NLP based;
   User text entry event: keyword cloud detection;
   User text entry event: question? Mark;
   User text entry event: question response as an answer;
   User button option selection event;
   Machine or third party text event, e.g. chat bot verb or noun;
   Text entry from user and or text delivery from third party;
   Complex detected multiple conditions as an If Boolean condition satisfied;
   Complex detected conditions as a fuzzy set e.g. linguistic non-Boolean evaluation range;

Frame Response Actions. Examples of frame state change triggered or “response” events that are encompassed within the scope of the described subject matter include:
Load new i-framed media content into one or more frames along with frame associated action buttons;
Provide additional button selections to choose from before changing any frame content;
Send text or voice message to designated party or parties or group: e.g. teacher or teacher assistant
Open chat window with designated other party or group;
Collect and emplace resource content results from initiated keyword or semantic or sentiment topic bounded search:
e.g. news search
e.g. image search
e.g. audio search
e.g. video search
e.g. RSS feed search
e.g. social messaging search
e.g. social support search
e.g. web information search
e.g. database search;
   Collect, format and emplace curated resources of indexed or searched news, images, audio, video, 3D objects;
   Indexed resources of models, simulations, wordplay, quizzes, puzzles, games, demonstrations, visualizations
   Human or artificial intelligence interaction and virtual teleconference.

The multi-frame screen display in the browser window autosizes all frame and associated content to be rendered to fit the available browser window size, available browser window screen real estate, display resolution, orientation, and display technology embodiment, enabling system functionality on a plurality of window sizes and device screen sizes, from mobile phone browsers, preferably used in landscape mode, to mobile tablets, laptops and desktop internet browsing capable devices. The entire compliment of operational capability for interactive multi-frame is differently arrayed, oriented, fitted, and rendered depending on the display technology embodiment of the described subject matter. The described subject matter is comprised of display subordinate adaptive organizing features in order to both enable and optimize deployment into a variety of different display technology device sizes and apparatus types. In the most common current day embodiment of the described subject matter, the multi-frame operational contains the capability to detect the particular absolute size, screen resolution, aspect ratio, and device type of the companioned display technology. When the software invoked to be loaded and deployed in a particular display device technology multi-frame operations system software that is served from a server device through a network using internet protocol identifies the device type and associated device features and display scope available, which data is utilized to adapt and direct the display rendering capability to mate with the available display device in the remote location. The mating process assures the multi-frame media content is alternatively rendered to utilize and operate with the device display available span, size, resolution, and interactive capability associated with the display, to therefore format the multi-frame graphical display components to optimize the multi-frame display and user interface interactive features to deploy within the available display parameters. The frames, the frame layout, the content within the frames and the interactive controls within the visual graphical layout of the multi-frame media content display are optimized and reformatted to utilize the particular available display area available, and the resolution, layout formatting, graphical resolution, display frame-rate, and visual interactive control elements such as buttons, are optimally fitted to the available display, whether mobile device display screen, mobile tablet device display screen, laptop device display screen, desktop device display screen, wearable device display screen, wall projection device display screen, or other types of display screens.

Display screen embodiments are applicable to all types and variants of current and emerging digital and analog and machine based display technologies, including flat displays, flat displays with touch interaction features, stereoscopic displays, projection displays, wearable displays, and 3D immersion displays used in VR for example. The multi-frame media content and user controls for display are formatted and rendered for example where the display parameters include stereoscopic parameters, using stereo pair discriminating glasses, or is auto-stereoscopic using head tracking or fixed viewing zone parallax panoramagram technologies with display capability that do not require glasses, whereby the multi-frame graphical media content is rendered in stereo pairs to be rendered in multiple viewing zones, and rendered in multiple stereoscopic third-dimensional depth layers with 3D frame depth or frame media content depth features or user interactive control graphic depth formatting. The described subject matter multi-frame display contents and controls can be rendered for display with integrated camera technology to be embodied and applied in an augmented reality (AR) type graphical rendering display device, with frames, frame media content, and user controls overlaid and often visually tethered or anchored to real world visual features by means of image recognition feature detection that is available for camera integrated AR display devices on tablets or mobile phones or as miniaturized into wearable digital data display glasses (e.g. Google glasses) or goggles (e.g. Microsoft Hololens). The system will render and detect display technology parameters integrated into display eyeglasses, or display eye contacts or directly laser scanned onto retinal surface as a wetware display. Further the multi-frame media and control contents can be reformatted and rendered for being embodied and applied in immersive virtual reality display technology using VR goggles, taken into account available virtual reality visual field available field of view that is designated for deployment of the multi-frame described subject matter capability. Further, it is anticipated the described subject matter may be applied for display using holographic projection spatial display technology, or applied for embodiment within a direct neuro-visual cortical stimulation interface display technology environment that is expected to become available in the market within the period of the coming decades of rapidly developing digital to analog neuro-interface technology that uses a variety of different means to effect visual display, whether non-invasive or invasive wetware neural interface technology based. In all of variant display technology embodiments of the multi-frame system configuration, editing, and application deployment includes the embodiment of the described subject matter capability for layout, rendering, fitment, interaction and content resourcing, formatting and processing technology and information network resourcing, and further each appropriately companioned to fit the variant display technology and media playback and integration method medium for optimizing visual experience, available display real estate, and user interface engagement and control capability present within the display device technology.

An embodiment of the described subject matter is optimized to permit non-programmer assembly, construction and population of dual or more than two frames within a single browser window, for displaying or playing or populating any type of internet accessible content that can be provisioned within a browser window, but is additionally is comprised of user action controls in the form of action buttons that exist external to the windowed content. These button action controls act as a default means by which the user can change or sequence a first framed content resource to another first frame content resource or other present frames for content resources. The backend GUI interface permits the teacher or assistant to label each of the content frames, associate each frame in a list of frames for that frame location within the larger container window, and further to associate each frame with a URL to designate and provision content within the frame, and set up buttons associated to each frame that control any action external to the window framed content.

In an embodiment of the described subject matter there are different types of button actions that are selectable to be added in association to each frame during initial construction, which in turn determines the type of frame-to-frame event stimulus- to response action activity, or entry and exit activity relative to any current frame, or entry or exit actions relative to the multi-frame content display as a combined resource, effecting entry into or exit from a browser window that is designated with its own URL which contain multiple information frames.

Specific button action types can include:

(1) next frame to sequence to within a collected labeled set of frames and whether such next selected frame shall be loaded into the first frame graphical location or another frame location and placement within the single containing browser window, and or;

(2) replace the current button associated frame on the same side, and/or;

(3) replace the opposite frame in the split frame display relative to the button location, and/or;

(4) if both frames on the left and right will be changed from a single button action, and/or;

(5) if a new labeled set of collected set of frames will be loaded, and/or;

(6) if said new collected set of frames shall load into the same browser window, and/or;

(7) if said new collected set of frames shall load into a new browser window under a separate browser tab, and/or;

(8) if the button action contains a URL to navigate the browser window to, thus leaving the dual or multi frame URL display, such as to a regular web page resource.

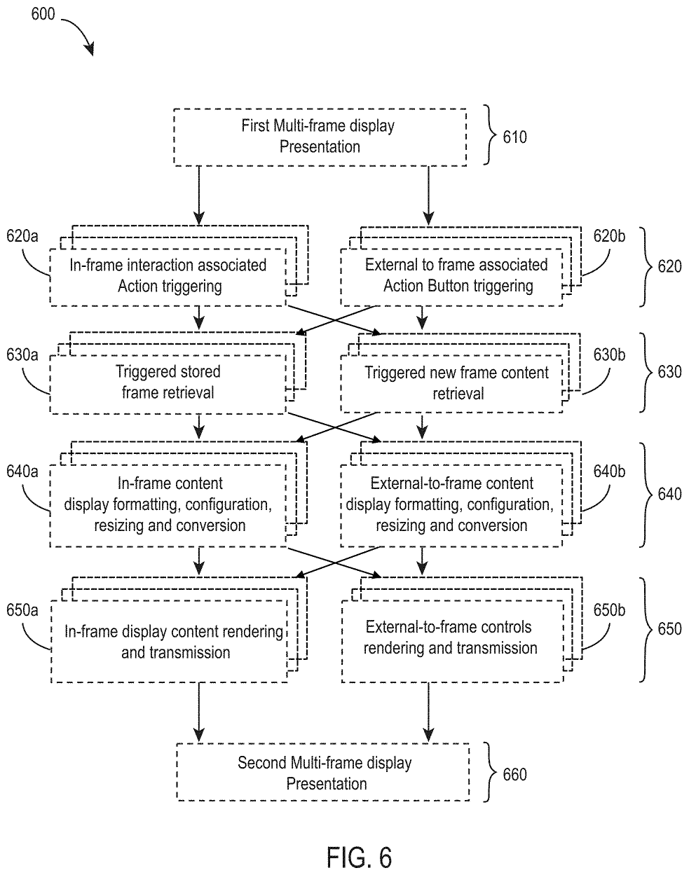

FIG. 6 illustrates a frame and multi-frame content retrieval processing 600. The process starts in step 610 with displaying a first multi-frame assembly. The process moves onto step 620 where:
an action corresponding to interaction with in-frame content is triggered in step 620a, and/or
an action corresponding to interaction with external to frame Action Button is triggered in step 620b.

Further, the process moves onto step 630 where:
retrieval of stored frame is triggered in step 630a, and/or
retrieval of new frame content is triggered in step 630b.

Next, the process moves onto step 640 where:
the content to be presented in the frame is formatted, configured, resized, and/or converted in step 640a, and/or
the content to be presented external to the frame is formatted, configured, resized, and/or converted in step 640b.

Next, the process moves onto step 650 where:
the in-frame content is rendered and transmitted in step 650a, and/or
the external to frame controls are rendered and transmitted in step 650b.

Further, the process includes step 660 comprising displaying a second multi-frame assembly.

An embodiment of the described subject matter provides in the backend construction system single button means to save designated frame content and their associated button action configurations and functions, and to clone or duplicate saved named collections of frames and buttons to then permit modification of such collections in some way to configure a variant collection of content and action choices.

As the student user engages and interacts with the deployed dual or split or greater than two-frame content in an embodiment, the system generates a student interaction log that is stored and utilized within a larger stored corpus of cohort interaction logs, which logs include:

(1) log with time stamps associated to actions and interactions within internal framed content, such as a quiz performance, selections made, and all student interaction events;

(2) log interactions via chosen button actions external to each frame, which button actions can include a plurality of choices for a student;

(3) log external actions entry and exit actions to the dual split screen or greater than two multiple-frame display layout;

(4) log cursor movement and dwell time intervals within and external to the multi-frame display;

(5) log audio utterances of the student, and log the external environmental audio environment;

(6) log eye movement of student users on the dual or multi-frame layout display and eye movement relative to external button options presented; and optionally

(7) log user biometric data including multi-region brainwave activity, galvanic skin response, skin temperature variability, heart rate and heart rate variability, breath rate, breath depth, and breath rate variability, blood pressure variability, blood oxygenation, head motion, facial expressions and expression variability.

In another embodiment of the described subject matter the system logs (1, 2, 3, 4) above are logged at minimum as part of the standard or default data logging setting, and (5, 6, and 7) data stream attributes are logged in specific learning settings where the teaching environment and student learning requirement have opted-in and are provisioned to permit such data logging. These data logging events and streams are collected for each student and time indexed across all logged data dimensions, including reference to the learning content and interactive action options. This provides a multiplex log for a given student interaction in relation a given dual screen or split screen content collection, or plurality of collections that are linked during an interactive learning engagement are stored within a larger library corpus of student logs.

This growing corpus of interaction logs provides learning interaction pattern data that is utilized during AI deep learning neural net training to produce learning pattern prediction which machine learning is in turn deployed in future learning to automatically reconfigure, prioritize and adaptively select displayed and presented frame content, available content frame sequences and associated button action opportunities to be displayed to future students. The human student learning process logging corpus of a cohort population of students provides a machine deep learning input resource that is used to adaptively reconfigure the frame resources and presentation of resource content in the dual display, and adaptively select possible action button options provided to the student to better optimize and beneficially manage rate, depth, and quality of learning, including comprehension, understanding, memory, and interactive student content learning and assimilation faculty, and further to optimize the learning experience to best personalize and adapt to the cognitive capacity and conscious emotional affect of the individual student, and in the setting of student groups or teams, the same measures the performance capability as social group or collaborative team.

The interactive GUI student learning interface is configured for using a backend GUI construction method and apparatus that enables nonprogrammer teachers and assistants to build, organize, sequence, choreograph, outfit and set up. The resulting configured multi-window display provides the student with interactive media functionality where interaction can occur within each side by side content window in the embodiment, and further student interactions with the deployed knowledge and media contents can trigger the sequencing of new windows that can replace the current window content displays with new contents.

Content for each dual window display can contain any be windowed from any local or remote third party resource on the internet including website content of any kind that is capable of being functionally present within a browser sub-window and typical web browser. Such content is pre-designated and chosen and selected by the users, such as teacher or assistant, to be present in the windows for student learning benefit. Further, in an embodiment of the described subject matter, displayed content may be selected by means of artificial intelligence based deep learning systems conditioned to select next content to be displayed to the student based on previously learned patterns from a larger cohort corpus of student learning patterns that are best fit paths to select relative to current student interactions being detected. The dual window content resourcing layout accommodates a plurality of knowledge mapping and a plurality of alternate learning styles. This split screen or dual frame content architecture provides an elegant placeholder system to embody greater than one aspect of knowledge itself and greater than one mode of learning comprehension.

Further, in an embodiment of the described subject matter, iframed embedded content if fixed as larger that the available frame space will typically be, zoomed to:

(1) auto-fit its content to the left and right width extent of the iframe, with any content that does not vertically fit within the frame is vertically accessible (a) via touch swiping up and down or (b) scrolling with the mouse wheel or (c) scrolling vertically using a traditional scroll control bar that is attached to the frame edge or floating in proximity to the frame area or (d) scrolled using a mouse position detection above or below a scroll anchor overlaid in proximity to the frame;

(2) auto-fit the embedded iframe content to both the horizontal and vertical available dimension of the frame, and permitting double click or double tap to zoom in and out of the autofitted content where the zoom is anchored to the location of the mouse cursor or finger tap.

Further, in another embodiment of the described subject matter, there is provided, external to the multi-frame content display and associated action buttons, additional companion resources with functionality that can be optionally used by the student in concert with any interaction with the multi-frame learning interface, positioned by preference in the browser window, including:

(1) An electronic student notebook that can be opened by clicking or tapping a button icon with text caption, which when selected opens a Notebook GUI interface where the student can enter textual notes, add images, links and other information, and which note taking interface preserves the association of the notes with the frames or collection of frames engaged.

(2) An electronic in-frame annotation capability that can be switched on, so that any content frames can be overlaid with student drawing or text entry and saved for later viewing when the student returns to the frame, and can additionally exported as captured images and inserted into the student notebook for later retrieval or export by the student or the teacher.

(3) A chat interface which can include animated avatars or text only interaction with teachers or other students.

(4) A discussion forum thread specific to the educational content.

(5) A search bar interface that can be used to search for relevant related news or other web resources, which search can be automated to show either curated set of searchable resources, or be an open search of the internet which results are provided either in a separate browser window tab, or a search results popup window overlay, or within a sidebar area.

(6) An curated RSS newsfeed that can be associated to situational learning content being exposited; which results are provided either in a separate browser window tab, or a search results popup window overlay, or within a sidebar area.

(7) A feedback messaging and comment box that when opened allows the student to enter text or draw information that is transmitted to other students or a teacher, or remains attached in a comment area associated to the present content frames in view or further associated with a named collection of frames under engagement.

(8) A stereoscopic 3D switch that converts the 2D browser display to a 3D stereoscopic viewable display of the frames, and iframe contents, as provisioned to be available for 3D iframe content, which 3D display layout is then viewed using either Virtual Reality (VR) goggles or other 3D viewing apparatus. 3D content in an embodiment of the described subject matter, when switched on, converts the multi-frame display into a three dimensional stereoscopic side-by-side frame pair for use with VR goggles or prism-based 3D viewer, or alternatively switches to alternating left/right eye view sequential 3D glasses viewable display, as for example used in stereoscopic 3D large screen television systems.

(8) Session recording that logs student interactions and can provide saved replay and summary of the students sequence of interactions for both teacher and be saved for later replay by the student.

(10) Text-to-Speech function where any content text words or segments within the iframe display frames or external to the frame display in the companion sidebar or popups, can be highlighted for speaking as audio from the text.

In an embodiment of the described subject matter there can be at least two or greater than the two frame side-by-side, such as a three or four window simultaneous arrayed in layout of the browser or software application window, wherein each of the plurality of windowed knowledge content can display a related knowledge alternate exposition expression or mapping, thus accommodating a more complex simultaneous content exposition or inquiry or expression, such as for examples: a theory frame, hypothesis frame and an experiment frame; or an apparatus frame and a experiment frame and a results analysis frame; or an input block, a processing block and an output block of a system; or a narrative window and a visual interactive simulation window and a student-teacher chat window.

The number of content windows can be alternately arrayed in a horizontal row, vertical stack or circular or matrix or other geometric array that is instantiated to accommodate the desired pedagogical multi-window content dimensionality deemed or found most useful to exposit and enable the learning experience. In this regard, the number of content screens of related knowledge content can be comprised of any arbitrary number of frames optimal to map, express and teach across multiple dimensions of related exposition. This method provides an adaptive content framing system that can fit to a preferred information or topical ‘chunking’ complexity of knowledge and pedagogy required for more optimal learning and comprehension within the capacity and aptitude of the student to successfully exercise, interoperate and interactively engage. This multi-window or multi-frame display can afford to have different degrees of complexity depending on the student demonstrated interest, capacity and learning efficacy.

In another embodiment, the described subject matter provides a backend configuration and construction GUI interface to generate and populate individual frames, sequences of frames, and available actions associated to each frame to effect inter-frame sequencing or changes. A web browser iframe URL and or iframe URL embed script method is utilized whereby each frame is a designated and associated to a separate iframe web content media resource that displays remote situated content within the browser window's sub-window visual frame.

Further, in the back-end assembly collections of frames are saved as collections which are labeled collections.

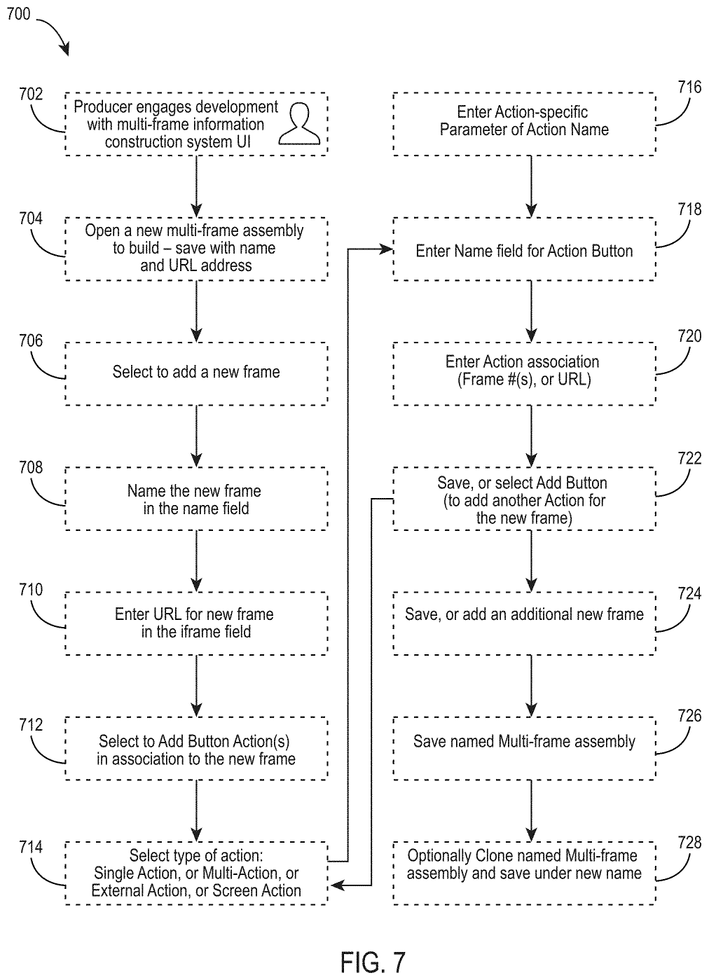

FIG. 7 illustrates a method 700 to use the back-end assembly interface for construction of multi-frame assembly. To initiate the multi-frame assembly process, a producer, such as teacher or assistant, engages development with the back-end construction system interface in step 702. Next, in step 704, the producer opens a new multi-frame assembly to build and saves with name and URL address. In step 706, the producer can select to add a new frame. Next, in step 708, the producer can provide a name to the new frame in a name field of the new frame, and in step 710, can enter URL for the new frame in an iframe field of the new frame.

Further, in step 712, the producer can select to add Action Button(s) in association to the new frame. The step of adding the Action Button can be followed with additional steps of selecting the type of the Action Button 9 (step 714), entering action specific parameters of the name (step 716), entering a name of the Action Button (step 718), and enter any action association for the Action Button, such as frame numbers or URLs (step 720). Next, the producer can either save the Action Button or add another Action Button in step 722. In case the producer selects to add another Action Button, the process of steps 714-720 can be followed again.

Once the Action Button(s) is/are configured, the producer can select to save the new frame in step 724. Optionally, the producer can add additional new frames with the steps of 706-724. In step 726, after configuring the frames, the producer can save the multi-frame assembly. In an optional step 728, the producer can select to clone the configured multi-frame assembly and save the cloned assembly under a new name.

Further, once the multi-frame assembly is configured with one or more frames and the associated action types, and stored as a collection, the collection can be displayed in a browser window of any display device.

In the back-end assembly interface each frame is given a designated address name, such as frame 1, frame 2, frame 3, and is associated with position 1, position 2, position 3, where in an embodiment where two frames are to be displayed, position 1 is designated the left frame and on the left side of the editor, and position 2 is designated as the right frame and shown on the right side of the editor.

One skilled in the art will appreciate that, for this and other methods disclosed herein, the functions performed in the methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

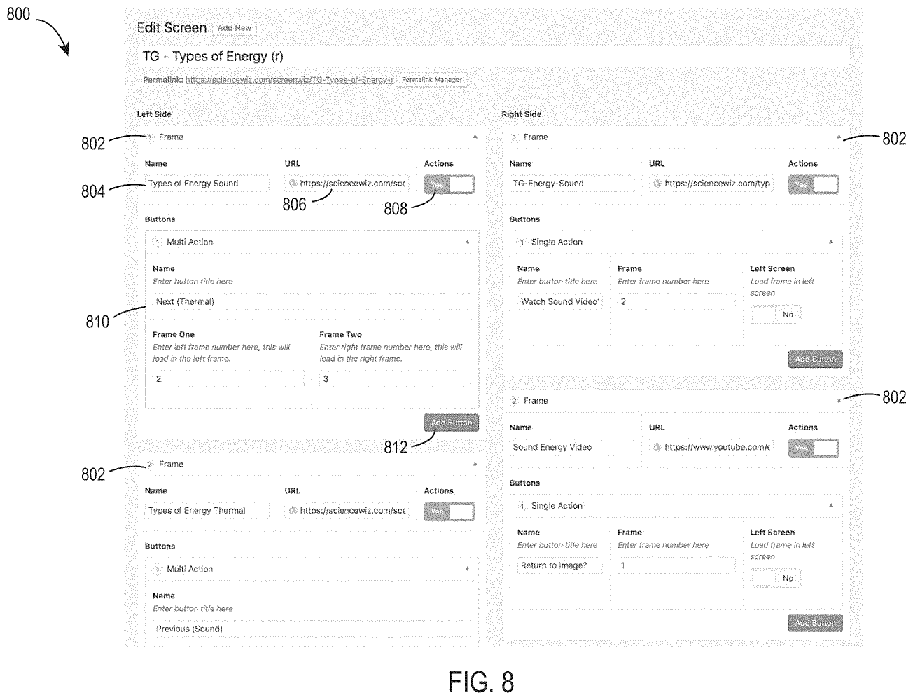

FIG. 8 illustrates a back-end assembly interface, i.e., a dual frame layout frame and button action editor 800 for configuring the multi-frame assembly and associated actions. Individual frame address designations 802 are automatically assigned as they are created in the back-end. Each frame provides a name field 804 where the title of the frame is entered as text or styled text, which is displayed over the top of the frame when present on the front-end to the student.

Each of multiple types of frames that can elected for use in the construction process provides a related set of configuration fields for the editor to populate and designate: The initial frame of any set of frames for a given position left or right, for example in a dual frame or split screen embedment, includes a frame name field 804 and a URL field 806 to populate, and an Action switch 808 to select. The action switch is set to ‘Yes’ or ‘No’, and if ‘Yes’ opens a new section 810 for that frame to define the Action Type. When an Action selected when the Actions =‘Yes’ switch position is chosen in the editor for the individual frame, an ‘Add Button’ button 812 appears below it.

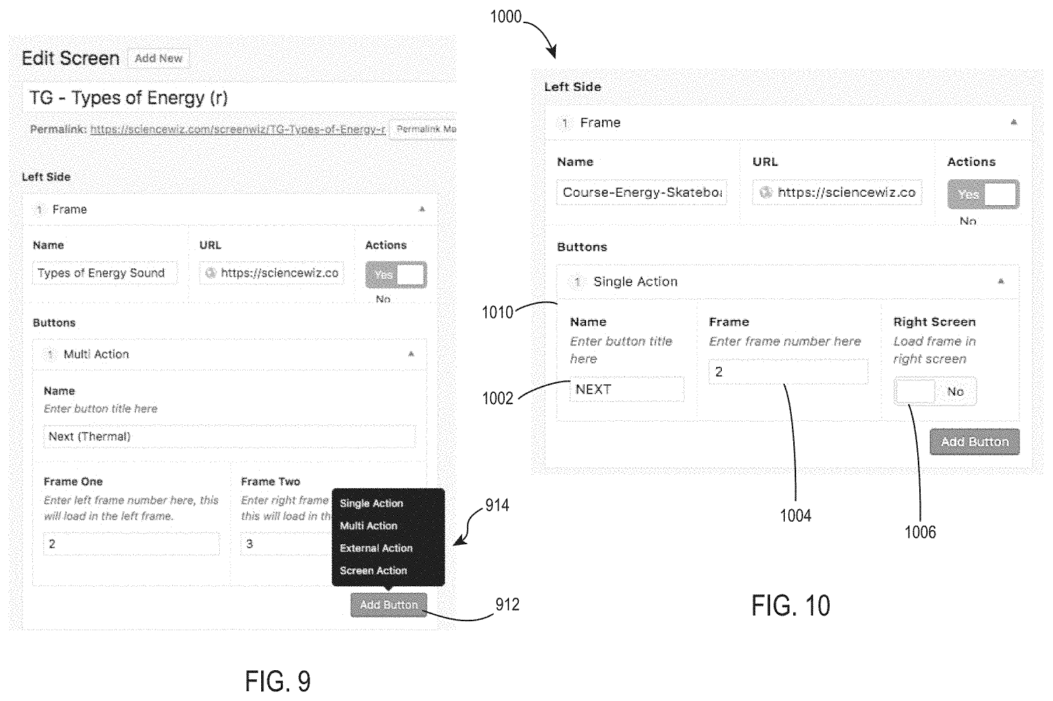

When the Add button is clicked or tapped, a submenu of Action Types is presented to the teacher or person assembling the frame capability within the editor. FIG. 9 illustrates the submenu of Action Types 914 in an add button action selector when Add button 912, corresponding to Add button 812 in FIG. 8, is clicked or tapped. These Action Types are subsequently following configuration thus presented on the front-end to the user as Action Buttons below the respective frame content for which button actions are being enabled and configured. In an embodiment of the described subject matter, there are four basic Action Types, single action, multi action, external action, and screen action, presented to the teacher in the submenu 914, which when configured generate one or a plurality of visible buttons for the student to select from below the associated frame. Any frame can have none, or one, or a plurality of Action Buttons situated below it for student interactive selection. After any button is defined and populated with its action functions, the back-end editor presents another ‘Add Button’ if there is another button to add to the frame.

Single Action frame button: FIG. 10 illustrates a single action button editor 1000 to configure a Single Action Frame Button. When selected in the back-end editor, a single action configuration section 1010 is presented. The section 1010 presents a button name text field 1002 to populate as the text or icon label. In an embodiment of the described subject matter the buttons can contain textual elements, or can include icon character elements such as those provided for use for example in the Font-awesome collection, a popular icon collection widely used on websites on the internet. When a textual label is employed there is a button style frame around the textual label. When an icon label is employed the icon can be naked without a surrounding button frame or be situated within a button frame. In another embodiment of the described subject matter the button can be replaced with images that act as one or more selectable buttons, and further multiple selectable button options below the content frame can be situated within different visual regions or features of a single image, similar to prior art image URL maps where an image can have multiple URL hotspots that can be hovered over to generate popup information windows, or clicked to navigate to embedded URL addresses. The Single Action configuration section 1010 additionally provides a Frame field 1004 to enter a frame number that will be loaded when the button is selected, and a switch 1006 to designate if the frame is to be loaded into the same position as the current frame or in the opposite frame, which is to the left or right depending on the location of frame and button which is being selected. Single Action frame button can additionally be self-referential, where the button action is reload the same frame, having the effect the starting over whatever iframe embedded content sequence for that same frame.

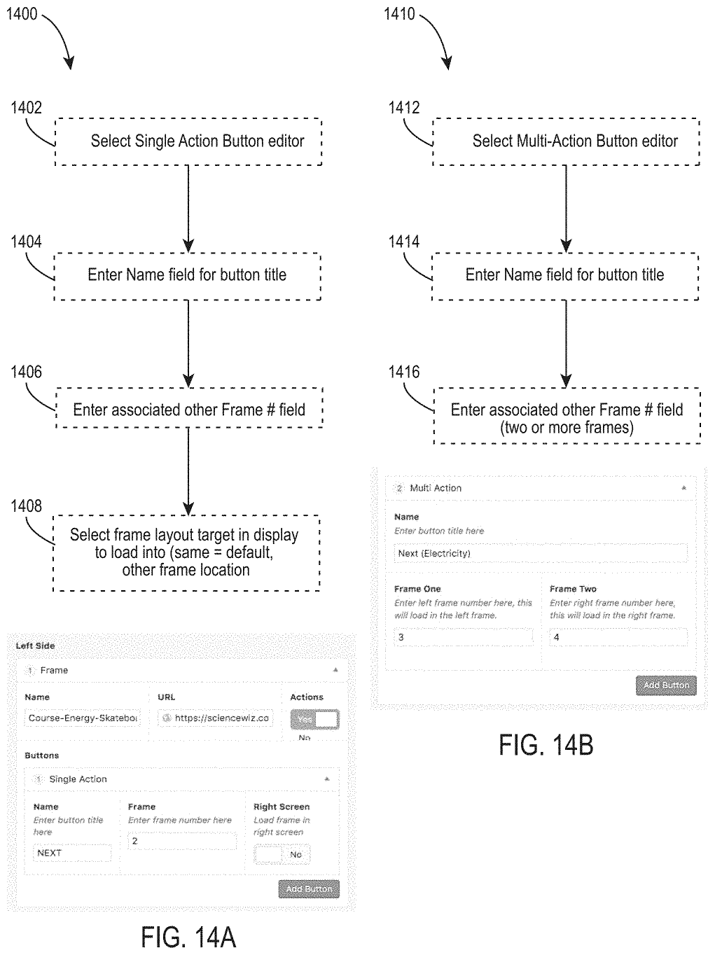

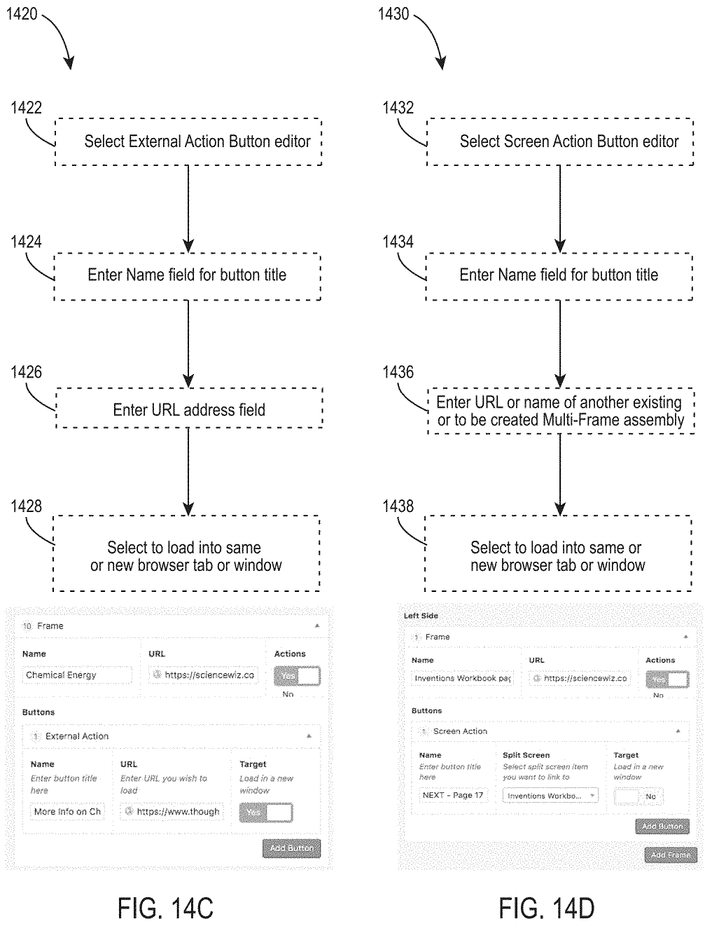

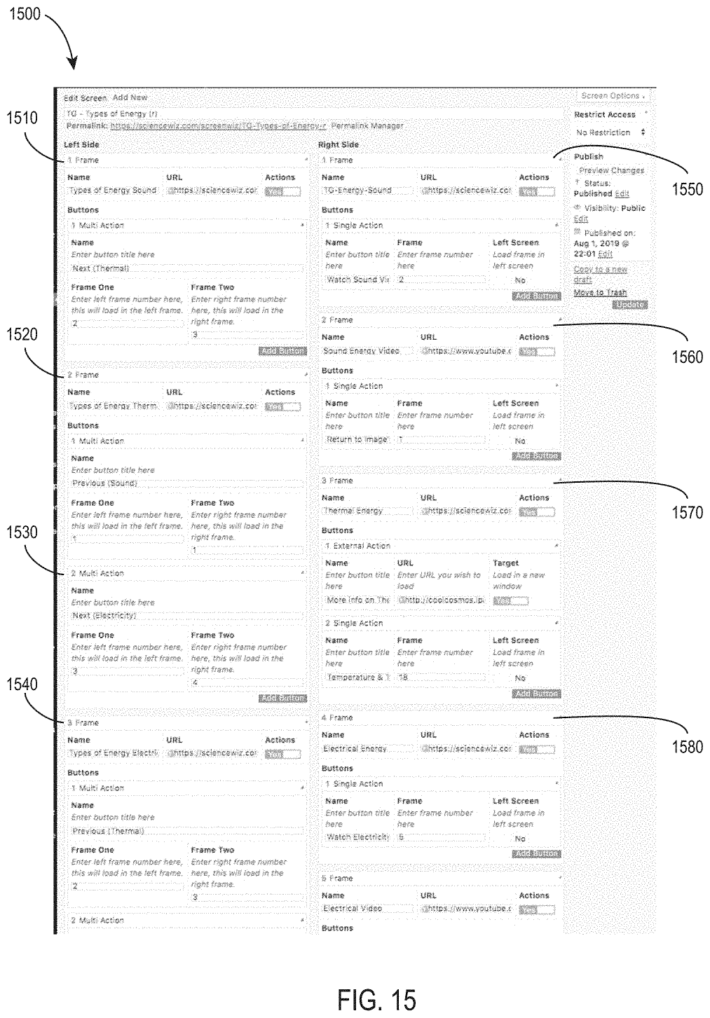

An exemplary process 1400 to configure and set up the Single Action Frame Button in the back-end editor is illustrated in FIG. 14A. In step 1402, the teacher or assistant selects the Single Action Button Editor. Next, in step 1404, the teacher provides a name for the button title, and in step 1406, provides an associated frame number for a frame that is to be loaded at a later time. Further, in step 1408, the teacher can select frame layout target in display by using a switch, to define where the frame is to be loaded or displayed.

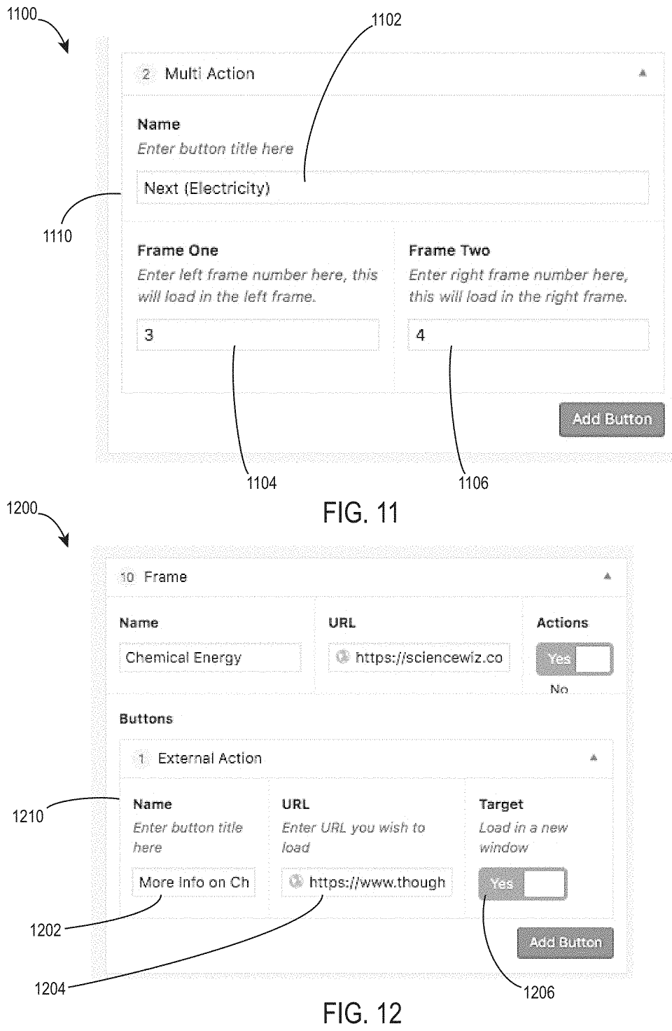

Multi Action frame button: FIG. 11 illustrates a multi action button editor 1100 to configure a Multi Action Frame Button. When selected in the back-end editor, a multi action configuration section 1110 is presented. The section 1110 presents a button name title field 1102 which can be textual or iconic in an embodiment of the described subject matter. The editor then provides two fields 1104, 1106 to designate two frames to change to, where a left frame and a right frame number can be entered. In other embodiments of the described subject matter these frames can be indicated in the field by either the frame automatic supplied frame number or with a frame title name to effect the same association to a target frame. For example, named ‘frame 1’ Multi Action button can embed within it both the title of the Action, which may or may not be opted to be displayed positioned as centered over both left and right frames, and name both ‘left frame 2’, and ‘right frame 2’ to be the target frames that will be loaded upon selection of this button by the student, thus changing the frame content for both left and right side at once by this action.

An exemplary process 1410 to configure and set up the Multi Action Frame Button in the back-end editor is illustrated in FIG. 14B. In step 1412, the teacher or assistant selects the Multi Action Button Editor. Next, in step 1414, the teacher provides a name for the button title. Further, in step 1416, the teacher can select associated other frames which are to be loaded or displayed at later stages.

(3) External Action frame button: FIG. 12 illustrates an external action button editor 1200 to configure a Multi Action Frame Button. When selected in the back-end editor, an external action configuration section 1210 is presented. The section 1210 presents a Name field 1202 to provide a button text title, or if an icon one can enter a icon retrieval script such as those used to identify and retrieve from a web an icon from the popular ‘Font Awesome’ font collection. The button action also provide a URL field 1204 to enter whereby a URL is entered, and provides a Target switch 1206 to designate if the URL is to load into the present browser window or in a new window.

An exemplary process 1420 to configure and set up the External Action Frame Button in the back-end editor is illustrated in FIG. 14C. In step 1422, the teacher or assistant selects the External Action Button Editor. Next, in step 1424, the teacher provides a name for the button title, and in step 1426, provides a URL. Further, in step 1428, the teacher can select whether frames are to be loaded or displayed in same browser window or tab, or a new browser window or tab.

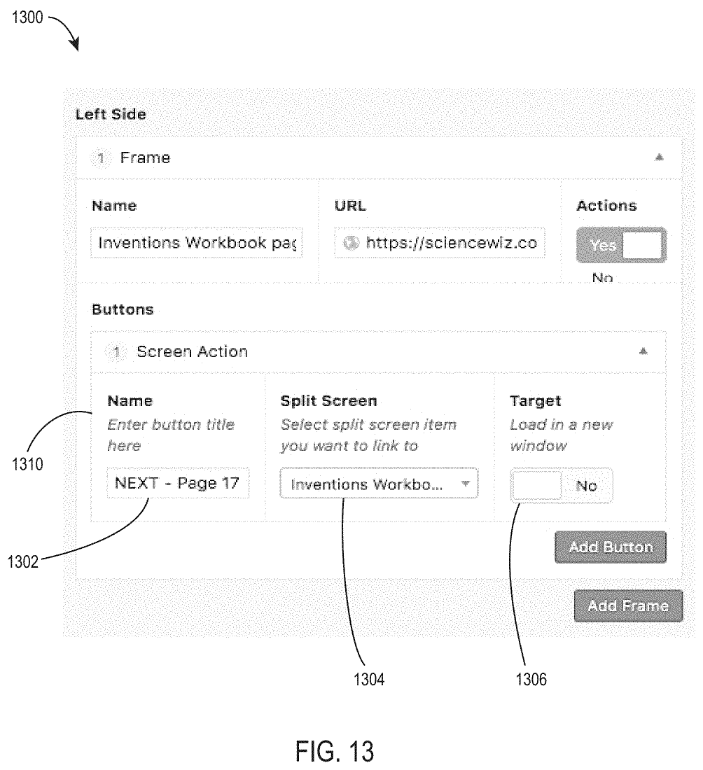

Screen Action frame button: FIG. 13 illustrates a screen action button editor 1300 to configure a Multi Action Frame Button. When selected in the back-end editor, a screen action configuration section 1310 is presented. The section 1310 presents a ‘Select’ button to populate a title field 1304 which in an embodiment provides a search bar to select another singly named collection of frames, and within the search bar the editor user can enter the first few letters of other named collections of frames to select from, which search auto-populates a submenu with matching named frame collection titles to select from whether or not any text is entered, which if entered narrows the number of drop down menu options to select from. Further, in an embodiment of the described subject matter both the target named frame collection to be loaded can be designated, but also which frames within that target collection will be loaded. This permits secondary frame collection entry at different numbered frames than the first frame in the left or right or ‘n’ stacks of frame positions. The section 1310 also provides a Name field 1302 to provide a button text title and a Target switch 1306 to designate if the frames are to be loaded into the present browser window or in a new window.

An exemplary process 1430 to configure and set up the Screen Action Frame Button in the back-end editor is illustrated in FIG. 14D. In step 1432, the teacher or assistant selects the Screen Action Button Editor. Next, in step 1434, the teacher provides a name for the button title, and in step 1436, provides a URL or name of another existing multi-frame assembly that is to be loaded. Further, in step 1438, the teacher can select whether frames are to be loaded or displayed in same browser window or tab, or a new browser window or tab.

Further, in an embodiment of the described subject matter, a frame or multiple frames or named multi-frame collection can be triggered to load without the use of Action Buttons, and instead be conditionally triggered by intra-frame software events that can message to the system to be load.

FIG. 15 illustrates a multi-frame sequence control stack configuration 1500 showing multiple frames configured by use of the back-end system. In an embodiment, the methods of FIGS. 14A-14D can be used to configure the multiple frames 1510 to 1580 in the multi-frame sequence control stack configuration 1500.

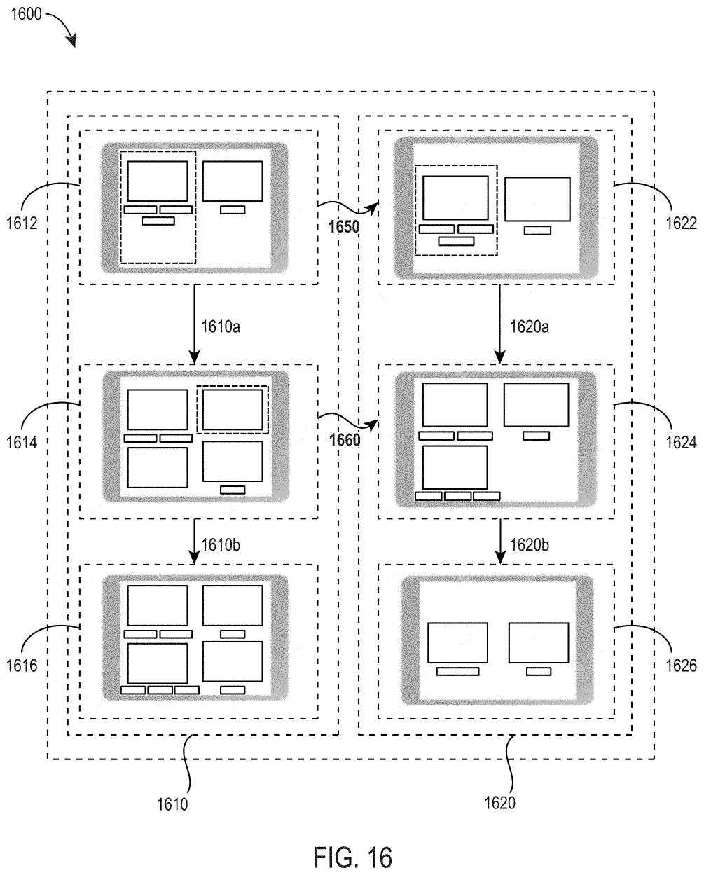

FIG. 16 illustrates interconnection flow between multi-frame assemblies in same or different collections. A plurality of multiple frames collections at multiple URLs are depicted at 1600, which includes single URL address multi-frame sequence collections 1610 and 1620. Collection 1610 includes multi-frame layouts (for instance, having left frames and right frames) with associated action buttons, depicted in FIGS. 16 at 1612, 1614, and 1616. Collection 1620 also includes multi-frame layouts with action buttons, depicted in FIGS. 16 at 1622, 1624, and 1626.

FIG. 16 further depicts state transitions of a multi-frame layout to another multi-frame layout within a same collection as well as from one collection to another collection. Arrow 1610a depicts state transition of multi-frame layout 1612 to multi-frame layout 1614 within the same collection 1610. Arrow 1610b depicts state transition of multi-frame layout 1614 to multi-frame layout 1616 within the same collection 1610. In a similar manner, arrow 1620a depicts state transition of multi-frame layout 1622 to multi-frame layout 1624 within the same collection 1620. Arrow 1620b depicts state transition of multi-frame layout 1624 to multi-frame layout 1626 within the same collection 1620.

In an example, state transitions within a same collection may be triggered by selection of Action Buttons associated with multi-frame layouts. The transition depicted by arrow 1620a may be triggered by selection of associated Action Buttons of multi-frame layout 1622, while transition depicted by arrow 1620b may be triggered by selection of associated Action Buttons of multi-frame layout 1624. In another example, selection of Action Buttons may trigger state transitions of a multi-frame layout in one collection to another multi-frame layout in a different collection. Arrow 1650 depicts a transition from multi-frame layout 1612 of collection 1610 to multi-frame layout 1622 of collection 1620. This transition is triggered by selection of the associated Action Buttons of multi-frame layout 1612. Similarly, selection of associated Action Buttons of multi-frame layout 1614 in collection 1610 may trigger state transition to multi-frame layout 1624 in collection 1620, depicted by arrow 1660.

As the teacher or educator or real person assembles and constructs a named collection of frames for both left and right side-by-side positioning, sequencing and switching, there may be an instance where there is a frame that may be removed from the collection of frames designated for the left or right side of the dual screen or split screen display. As the sequential ascending numbered naming of frames that are added over time during the manual construction process, any associated or linked button action frame references need to be preserved. Instead of simply deleting a given numbered frame and no longer using that frame number designation, the system preserves relational inheritance of frame and button action relations so, for example, when a right-side located named frame #3 is deleted from the right side frame stack in the editor, frame #4 is renamed frame #3 and all button action frame textual names, references and operational relations between frames in the stack are preserved correctly by also being similarly decremented. This inheritance feature within a single named frame collection or frame sequence stack is also preserved between named plurality of collections of frames, and detected to effect referential associated frame renaming the extent the given named frame collection possesses any Screen Action buttons that will load another affected frame or frame collection. In this way specific frame-to-frame relationships are preserved overall if any frames are removed from the collection.

Conversely, if a new frame is added and inserted into a pre-existing sequentially numbered frame collection, subsequence numbered frames can optionally be incremented to produce a consecutive numbered series of frames without loss of any pertinent frame to frame associations or references. If a frame that is removed is referenced for action specifically by other prior existing frames, the system alerts the developer of the existence of a now dangling or invalid frame reference that must be corrected. Further, the system offers the developer an “undo” button to revert to restore deleted frame that caused the no longer valid frame reference.

In another embodiment of the described subject matter there is a deployment mode that works to automatically extract data from the real-time streaming or transacting content of one frame to identify match conditions to trigger loading of available context to another frame. This is expressed in one case through the activity engagement occurring in one frame between the student user and a responsive digital assistant. This is similar to contemporary so-called “smart speakers” where users speak commands or ask questions to a microphone enabled device that supports speech recognition, such as available for example with Apple Siri, Google Assistant, or Microsoft Cortana or Amazon Alexa.

In an embodiment of the described subject matter, one frame has an animated avatar “smart” or AI trained character that speaks to and asks questions of a user, and also the user also speaks to and asks questions of the AI expert system. There is content transaction occurring between the AI character and the user that includes, amongst other streamed data, textual information. The multi-frame system has access to an index of frame content that is either curated by a teacher or by an algorithm that is collecting content from existing internet resources, including search engines. The multi-frame system management functionality includes a monitoring subsystem that perform real-time logging of user transactions within any frame and overall as a total user session that includes engagement with a plurality of frame content.

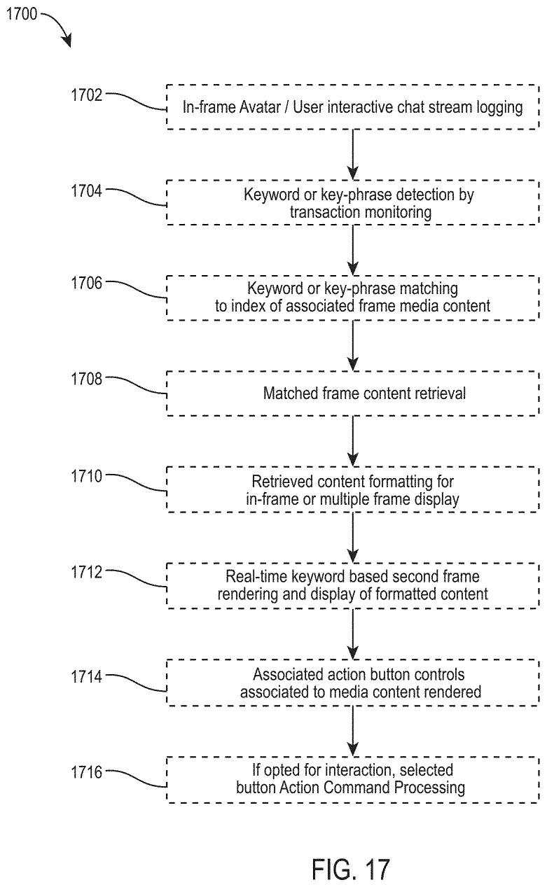

FIG. 17 illustrates a method 1700 for frame content detection for multi-frame frame triggering. In step 1702, the system logs the real time interaction between an Avatar in a first frame and a user. In step 1704, the system monitors the interaction and performs keyword or key-phrase detection. In step 1706, the detected keyword or key-phrase are matched to an index of associated media content. Next, in step 1708, the matched frame content is retrieved by the system. Further, the retrieved content is formatted in step 1710 for in-frame or multiple frame display. After the formatting, a second frame is rendered in step 1712 for display of the formatted content, which content is based on the real-time keyword detection. In step 1714, action buttons controls may be associated to the rendered media content. Further, in step 1716, the action buttons are linked to the required action types to define the action command and function.

In one example, the user or student interacts with an intelligent interactive assistant in one frame or window, such as an expert system teaching assistant, and the dialog that occurs with the user elicits a response from the user which contains a keyword or key phrase that exists within an established index, and when that match is detected, it triggers switching in content to a second frame or window with fairly low latency.

In one deployed example an animated character AI teaching assistant expert system operating in a left side frame asks a student “What is the name of an animal that has feathers?” and the student replies “An eagle”, then almost immediately in the right side additional frame, a picture or video or animation of an eagle is loaded. The digital teaching assistant then asks “What kind of animal is an eagle”, and the student replies “A bird”, and detecting that keyword triggers the loading of a graphic image of a group of different kinds of birds. The expert teaching assistant goes on to then ask, “Name 3 species of birds that are not eagles that people often eat”, and the student responds “A duck, a chicken and a turkey”, and then detecting each of those three keyword names, the system loads three images of those birds and plays them as a repeating slideshow. This is an example of transactional multimedia synchronization that assist the teaching and learning process through the introduction of relevant companion information related to the unpredicted transaction activity between the user and the user interface engagement system comprised within the multi-frame, multi-window, multi-screen, multi-media experience.

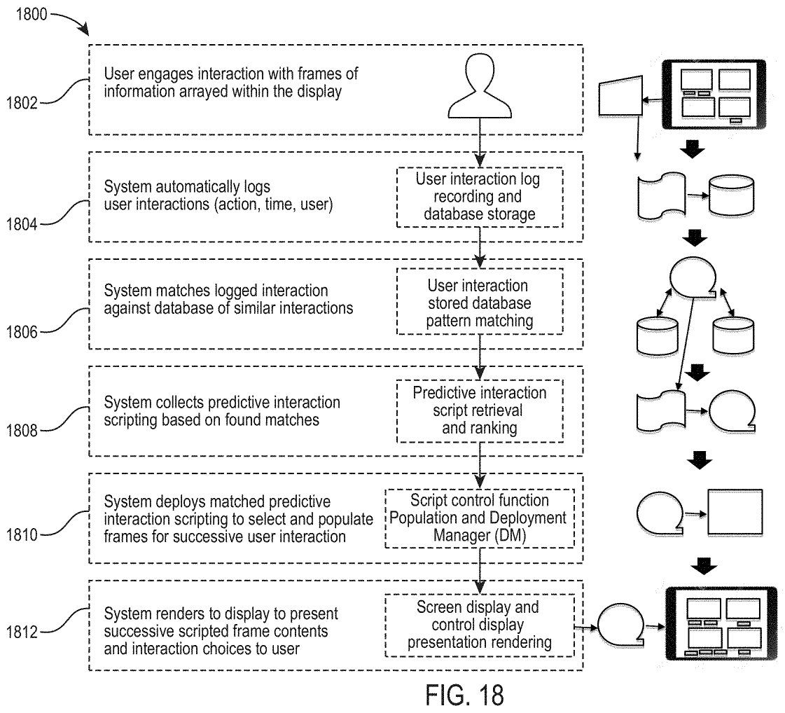

FIG. 18 illustrates a method 1800 for predictive interaction pattern matching, to predict most optimal interaction choices for a student. In step 1802, user engages interaction with frames of content, such as AI chat box character, arrayed within the display. In step 1804, the system automatically logs user interactions such as actions, time, etc in a database. Without prior specific prior curation of media content to be provisioned in real-time to a second frame triggered by interactions within a first frame, the system monitors the interactions between a digital teaching assistant and a student, and upon matching against keywords in a permissible keyword index, retrieves information or media from permissible online resources via search engines of media or content related to those keyword or key-phrase detections, which when matched and found is captured, formatted and rendered for display in a separate frame or multiple frames for the student to view. For example, three resources found can be optionally designated to appear in three new frames to placed on the larger container window or sequenced within three single frames to be positioned in the same frame location layout of the available area within the display screen.

When user is engaging dialog with an AI chat bot character in a first window a REST API based background transaction monitoring system, in step 1806, reads the real time text statements or questions transacting in the first window to identify keywords or key phrases that match a stored database of correlate text or media, which is then is triggered in real time to display or play in a second window or a additional plurality of windows. In other words, media and textual events monitored in real time between user-to-user agencies or between user to machine agency transactions conducted in a first window are matched against a background resource of additional textual and media and provisioned in real time to be played or displayed in a second window.

The matching mechanism may consist of simple keyword or key phrase matches found or latent semantic matches found or external process content concurrent activity resource matches found or AI trained deep learning matches found.

In step 1808, predictive interaction scripting based on the matches is collected. In step 1810, the matched predictive interaction scripting is deployed to select and populate frames for successive user interaction. Further, real time content matches found of any kind are in turn imported into a second window for playing or displaying, in step 1812 in context with the matches activity in the first window.

The playing or displaying of found match content in the second window may be preceded by presentation in or proximal to the second window of a single or plurality of labeled links to found match content, providing the user the option to select any match for playing or displaying from an available pool of real time discovered matching content.

In another embodiment, the matching content may possess relative match strength and be ranked by the degree of match precision or match relevance strength for the user.

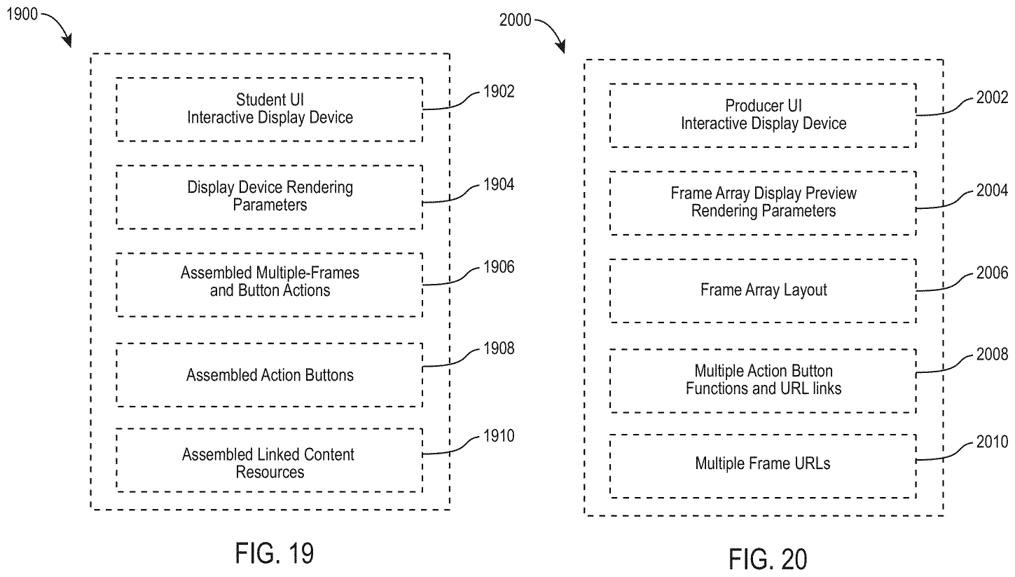

FIG. 19 illustrates a Multi-Frame configuration stack 1900 for a student, that comprises Student UI Interactive Display Device 1902, Display Device Rendering Parameters 1904, Assembled Multiple-Frames and Button Actions 1906, Assembled Action Buttons 1908, and Assembled Linked Content Resources 1910.

FIG. 20 illustrates a Multi-Frame configuration stack 2000 for a producer, such as teacher or assistant, including Producer UI Interactive Display Device 2002, Frame Array Display Preview Rendering Parameters 2004, Frame Array Layout 2006, Multiple Action Button Functions and URL links 2008, and Multiple Frame URLs 2010.

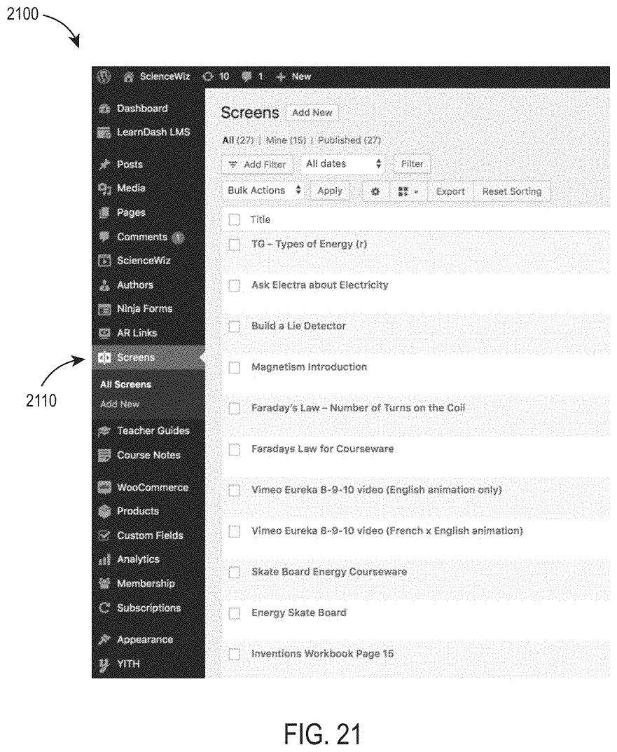

In an embodiment of the described subject matter illustrated in FIG. 21, the entire facility for assembly, construction and deployment for student interactive use is contained within a code collection that is configured to operate as a plugin 2110 that can be readily added to a website, or integrated into a learning management system 2100, such as the following examples:

(1) as a plugin in a Content Management System (CMS) such as Wordpress, Joomla!, Drupal, Magento, Adobe Dreamweaver, TYPO3, Shopify, Brix, Gray, Squarespace, Wix, Weebly, Magnolia, and Bynder.

(2) as a plugin in a Learning Management System (LMS) or online training systems such as LearnDash, WP Courseware, Docebo, Adobe Captivate Prime, Litmos LMS, GnosisConnect, Edvance360 LMS, iSpring Learn, Talent LMS, The Academy LMS, Kallidus Learn, Administrate LMS, Looop LMS, Knowledge Anywhere LMS, Pathwright LMS, Absorb LMS, Skyprep LMS, Moodie open source LMS, Chamilo open source LMS, Canvas open source LMS, Open edX LMS, Totara LMS, Torch LMS, Versal, Coassemble, Bridge, Mindflash, PiiQ, Saba Cloud, Auzmor, Edmodo, Blackboard Learn, WizIQ, Brightspace, Easy LMS by Quizworks, Articulate 360, eLearning Cloud by Vairkko, Kenexa, and Digital Chalk.

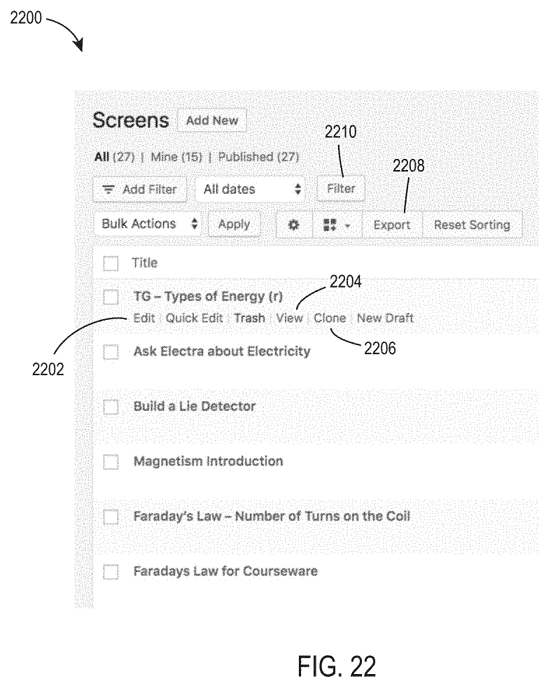

FIG. 22 illustrates a plurality of frame collections called Screens 2200 that are labeled for identification and have their own URLs. When managing the plurality of named frame collections in an embodiment of the described subject matter, the editor provides options to Edit a saved collection using Edit button 2202, to View a saved collection using View button 2204, to Clone or duplicate a saved collection using clone button 2206, to Export a saved collection to CSV format using Export button 2208, and conversely Import a CSV format saved collection. The named collections list can be filtered or sorted by name, date created or date modified, or deleted, using Filter button 2210. Further a plurality of named frame collections can be given a common tag or category association so they can be sorted or and viewed as a related group of named frame collections.

The term “computer-readable media” as used herein refers to any medium that provides or participates in providing instructions to the processor of the computer (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Although the present described subject matter has been described in terms of certain embodiments, various features of separate embodiments can be combined to form additional embodiments not expressly described. Moreover, other embodiments apparent to those of ordinary skill in the art after reading this disclosure are also within the scope of this described subject matter. Furthermore, not all of the features, aspects and advantages are necessarily required to practice the present described subject matter. Thus, while the above detailed description has shown, described, and pointed out novel features of the described subject matter as applied to various embodiments, it will be understood that various omissions, substitutions, and changes in the form and details of the apparatus or process illustrated may be made by those of ordinary skill in the technology without departing from the spirit of the described subject matter. The described subject matters may be embodied in other specific forms not explicitly described herein. The embodiments described above are to be considered in all respects as illustrative only and not restrictive in any manner Thus, scope of the described subject matter is indicated by the following claims rather than by the above description.

What is claimed is:

1. A computer-implemented method for multidimensional media content organization and presentation, the method comprising:
receiving one or more inputs from a user, defining at least a sequence for a plurality of content frames comprising portions of the multidimensional media content;
organizing the plurality of content frames into a frame collection based on the one or more inputs, the frame collection depicting the organized multidimensional media content;
storing the frame collection; and
displaying the frame collection within a browser window of a display device.

2. The computer-implemented method according to claim 1, wherein the one or more inputs include functional association of at least one of the plurality of content frames with at least another of the plurality of content frames.

3. The computer-implemented method according to claim 1, wherein the one or more inputs include:
a number of content frames to be displayed simultaneously within the browser window; and
a respective display position for each of the plurality of content frames with respect to other content frames within the browser window.

4. The computer-implemented method according to claim 1, wherein the one or more inputs include a respective media content URL for each of the plurality of content frames, the media content URLs being associated with resources of the corresponding portions of the multidimensional media content.

5. The computer-implemented method according to claim 1, wherein the one or more inputs include one or more action types to be associated with at least one of the plurality of content frames, wherein the one or more action types include a multiple action function, a single action function, a screen action function, and an external action function.

6. The computer-implemented method according to claim 5, wherein the one or more inputs include action functions corresponding to the one or more action types.

7. The computer-implemented method according to claim 6, wherein the action functions define at least one of:
at least one next content frame in the sequence for the plurality of content frames;
a next portion of the multidimensional media content in the corresponding content frame;
position of at least one next content frame within the browser window;
triggering a chat box;
prompting a user interaction;
sending text and/or voice messages;
triggering an external web page resource;
monitoring user interaction with the plurality of content frames, and triggering a related content based on the monitoring; and
triggering another frame collection.

8. The computer-implemented method according to claim 1, the method further comprising, after storing the frame collection, receiving one or more additional inputs for at least one of editing, viewing, cloning, and exporting the saved frame collection.

9. The computer-implemented method according to claim 1, wherein displaying the frame collection comprises displaying at least two of the plurality of content frames and corresponding portions of the multidimensional media content.

10. The computer-implemented method according to claim 1, wherein:
the one or more inputs include:
a number of content frames to be displayed simultaneously within the browser window, the number of content frames to be displayed simultaneously within the browser window being at least two;
a respective display position for each of the at least two content frames with respect to other content frames within the browser window, and
functional association of at least one of the at least two content frames with at least another of the at least two content frame; and
displaying the frame collection comprises displaying the at least two content frames adjacent to each other within the browser window, thereby providing graphically separated and functionally associated content engagement.

11. The computer-implemented method according to claim 6, wherein displaying the frame collection further comprises:
detecting a stimulus event associated with at least one of the plurality of content frames;
triggering at least one action function associated with the at least one content frame; and
changing the display in response to the triggering.

12. The computer-implemented method according to claim 11, wherein the stimulus event comprises a user interaction associated with the at least one of the plurality of content frames, and wherein the triggering at least one action function comprises prompting a further user interaction, the displaying the frame collection further comprising:
receiving the further user interaction;
generating an interaction log based on the user interaction and the further user interaction; and
storing the interaction log in association with the frame collection.

13. The computer-implemented method according to claim 12, wherein the further user interaction comprises at least one of addition of notes, annotations, chat, discussion forum inputs, feedback messaging, and request to view stereoscopic 3D content, speech inputs.

14. The computer-implemented method according to claim 12, wherein the interaction log comprises time stamps associated with the user interaction and the further user interaction.

15. A computer-readable medium that comprises computer-executable instructions for multidimensional media content organization and presentation, the computer-executable instructions, based on execution by at least one processor of a computing device that includes memory, cause the computing device to perform the method according to claim 1.

16. A system for multidimensional media content organization and presentation, the system comprising:
at least one processor; and
a memory that is coupled to the at least one processor and that includes computer-executable instructions, wherein the at least one processor, based on execution of the computer-executable instructions, is configured to perform the method according to claim 1.
